(19) United States
(12) Patent Application Publication
(10) Pub. No.: US 2006/0193302 A1
(43) Pub. Date: Aug. 31, 2006

(54) Information processing apparatus

(76) Inventor: Toshikazu Morisawa, Tokorozawa-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/361,904

(22) Filed: Feb. 24, 2006

(30) Foreign Application Priority Data
Feb. 28, 2005 (JP) 2005-052695

(51) Int. Cl. H04Q 7/24

(52) U.S. Cl. 370/338

(57) ABSTRACT

According to one embodiment, an information processing apparatus capable of executing wireless communication, includes a wireless communication unit which includes a transmitter and a receiver, and which executes the wireless communication using a predetermined frequency band wireless signal, a power control unit which supplies an operating power to the receiver when the information processing apparatus is in a power-off state, and an indication unit which indicates status information showing wireless communication environment corresponding to a current position of the information processing apparatus in accordance with a strength of the wireless signal received by the receiver.

### CROSS-REFERENCE TO RELATED APPLICATIONS

This application is based upon and claims the benefit of priority from Japanese Patent Application No. 2005-052695, filed Feb. 28, 2005, the entire contents of which are incorporated herein by reference.

### BACKGROUND

1. Field

One embodiment of the invention relates to an information processing apparatus such as a personal computer and, more particularly, to a wireless communication executable information processing apparatus.

2. Description of the Related Art

In recent years, various notebook personal computers having a wireless communication device complying to an institute of electrical and electronics engineers (IEEE) 802.11 standards (wireless local area network) have been developed. This kind of computer executes a wireless communication with an external network such as the Internet when the computer exists in a public wireless LAN service area.

Recently, a computer having a function of searching for a nearest public wireless LAN service area has been developed. The search function is usually realized using a wireless communication device and software controlling the wireless communication device. For this reason, the search function is available in a state that the computer is powered on; however, it is unavailable in a state that it is powered off.

Japanese Patent Application KOKAI No. 2004-104552 (hereinafter, document 1) discloses a technique of making detection that an information terminal is moved to a wireless LAN available area. According to the technique, a special detector (sensor) attachable to the information terminal detects radio signal strength. The detector is configured to be supplied with operating power using a received radio signal. Thus, the detector has no need of power supply from the information terminal. Therefore, even if the information terminal is in a power-off state, the detector can detect the strength of the received radio signal.

According to the technique disclosed by the above document 1, the information terminal must be provided with a special detector for detecting the strength of the received radio signal, in addition to the wireless communication device.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the appearance of an information processing apparatus according to an embodiment of the present invention;

FIG. 2 is an exemplary block diagram showing the system configuration of the information processing apparatus shown in FIG. 1;

FIG. 3 is an exemplary block diagram showing the system configuration of a wireless local Area network (LAN) device;

FIG. 4 is an exemplary block diagram showing a first system configuration of the wireless LAN device shown in FIG. 3;

FIG. 5 is an exemplary block diagram showing a second system configuration of the wireless LAN device shown in FIG. 3;

FIG. 6 is an exemplary flowchart for explaining a procedure of a status display function executed when a wireless LAN service area detection button provided in the information processing apparatus of FIG. 1 is operated; and

FIG. 7 is an exemplary flowchart for explaining a procedure of a status display function executed when a wireless communication button provided in the information processing apparatus of FIG. 1 is operated.

### DETAILED DESCRIPTION

Various embodiments according to the invention will be described hereinafter with reference to the accompanying drawings. In general, according to one embodiment of the invention, an information processing apparatus capable of executing wireless communication, includes a wireless communication unit which includes a transmitter and a receiver, and which executes the wireless communication using a predetermined frequency band wireless signal, a power control unit which supplies an operating power to the receiver when the information processing apparatus is in a power-off state, and an indication unit which indicates status information showing wireless communication environment corresponding to a current position of the information processing apparatus in accordance with a strength of the wireless signal received by the receiver.

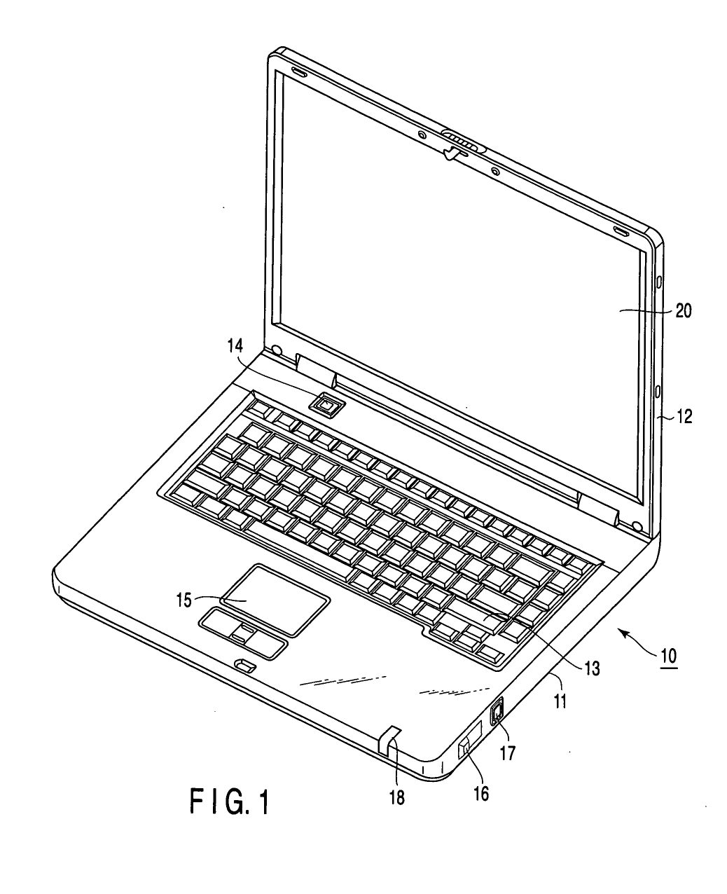

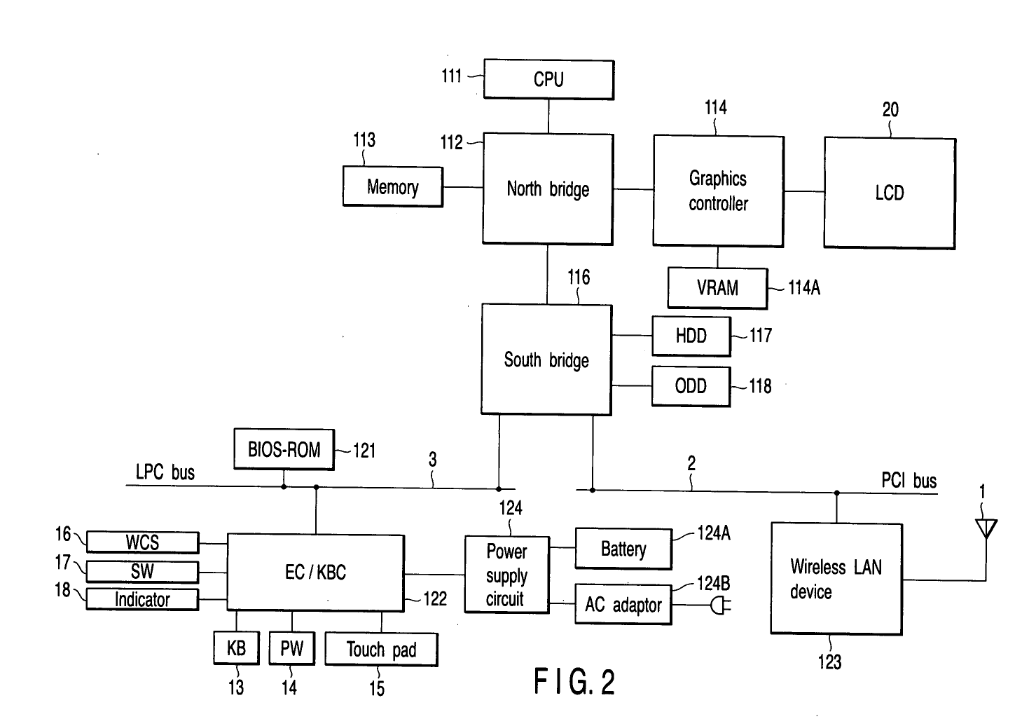

The configuration of an information processing apparatus according to one embodiment of the present invention will be described below with reference to FIG. 1 and FIG. 2. The information processing apparatus is a notebook type information processing apparatus, and realized as a notebook personal computer 10.

FIG. 1 is a perspective view showing a state that a display unit of the notebook personal computer 10 is opened. The computer 10 includes computer body 11 and display unit 12. The display unit 12 has a built-in display device comprising a liquid crystal display (LCD) 20. A display screen of the LCD 20 is located substantially at a center of the display unit 12.

The display unit 12 is supported on the computer body 11, and rotatably attached between a closed position with the upper surface of computer main body 11 is covered and a release position with respect to the computer body 11. The computer body 11 has a thin box-type housing, and the upper surface is provided with a keyboard 13, a power button 14 for powering on/off the computer 10, and a touch pad 15. The computer body 11 is further provided with wireless communication switch 16, wireless local area network (LAN) service area detection button 17 and indicator 18.

The computer body 11 has a built-in wireless LAN device as a wireless communication device. The wireless LAN device executes wireless communications with a wireless service area such as public wireless LAN service area provided via a wireless LAN access point (base station).

The wireless communication switch 16 is an operation switch for powering on/off the wireless LAN device built in the computer body 11. The wireless communication switch 16 is a two-state switch having the following two states. One is an on state of instructing to power on the wireless LAN device, and another is an off state of instructing to power off the wireless LAN device. When user sets the wireless communication switch 16 to the on state in a state that the computer 10 is powered on, the wireless LAN device is powered on. On the other hand, when user sets the wireless communication switch 16 to the off state in a state that the computer 10 is powered on, the wireless LAN device is powered off.

The wireless LAN service area detection button 17 is an operation switch instructing to execute a search function for searching a public wireless LAN service area near to the computer 10. The wireless LAN service area detection button 17 is arranged on an externally exposed position of the computer body 11 (e.g., side of the computer body 11) in a state that the display unit 12 is the closed position so that user is operable even if the display unit 12 is in a closed position state.

The indicator 18 is a light emitting diode (LED) indicator, for example. The indicator 18 is a indication unit which indicates status information showing a wireless communication environment corresponding to the current position of the computer 10 in accordance with the strength of a radio (wireless) signal received from the wireless LAN service area searched by the foregoing search function.

For example, the status information shows a radio signal strength level of a wireless signal from a wireless LAN access point received by the wireless LAN device. The indicator 18 is arranged on an externally exposed position of the computer body 11 (e.g., front side of the computer body 11) in a state that the display unit 12 is the closed position so that user can visibly confirm the indicator 18 even if the display unit 12 is in the closed position.

The computer 10 has a function of receiving a wireless signal from a wireless LAN access point when user operates the wireless LAN service area detection button in a power-off state of the computer 10, and a function of displaying the radio strength of the received wireless signal in the indicator 18 as status information.

The system configuration of the computer 10 will be described below with reference to FIG. 2. The computer 10 is provided with a CPU 111, a north bridge 112, a main memory 113, a graphics controller 114, the LCD 20, a south bridge 116, a hard disk drive (HDD) 117, and an optical disk drive (ODD) 118. The computer 10 further includes a BIOS-ROM 121, an embedded controller/keyboard controller IC (EC/KBC) 122, a wireless LAN device 123, and a power supply circuit 124, and the like.

The CPU 111 is a processor provided for controlling the operation of various components of the computer 10. The CPU 111 executes operating system and various application programs loaded from the HDD 117 to the main memory 113. The CPU 111 executes a system basic input output system (BIOS) stored in the BIOS-ROM 121. The system BIOS is a program used for controlling hardware.

The north bridge 112 is a bridge device for connecting between a local bus of the CPU 111 and the south bridge 116. The north bridge 112 has a function of executing communications with the graphics controller 114 via an accelerated graphics port (AGP) bus.

The graphics controller 114 is a display controller for controlling the LCD 20 used as a display monitor of the computer 10. The graphics controller 114 generates a display signal to be transmitted to the LCD 20 on the basis of video data written in a video memory (VRAM) 114A. The south bridge 116 has a built-in an integrated drive electronics (IDE) controller for controlling the HDD 117 and the ODD 118. The south bridge 116 connects various devices via a peripheral component interconnect (PCI) bus 2 and a low pin count (LPC) bus 3. The PCI bus 2 is connected with the wireless LAN device 123. The LPC bus 3 is connected with BIOS-ROM 121 and EC/KBC 122.

The HDD 117 is a storage device storing various software and data. The ODD 118 is a drive unit for driving storage medium such as digital versatile disc (DVD) and compact disc (CD).

The EC/KBC 122 is a one-chip microcomputer, which integrated with embedded controller for power management and keyboard controller for controlling the keyboard (KB) 13, the power button 14 and the touch pad 15. Moreover, the EC/KBC 122 has a function of controlling wireless communication switch (WCS) 16, wireless LAN service area detection button (SW) 17 and indicator 18. The power supply circuit 124 is connected with a battery 124A and a AC adaptor 124B.

The EC/KBC 122 has a function of operating in association with the power supply circuit 124, thereby powering on/off the computer 10 in accordance with user operation of the power button 14. The power supply circuit 124 generates a system power to be supplied to various components of the computer 10 using external power supplied via the AC adaptor 124B or power from the battery 124A.

The wireless LAN device 123 is a wireless communication device which is for example, complying to institute of electrical and electronics engineers (IEEE) 802.11 standards. The wireless LAN device 123 executes wireless communications with the wireless LAN service area access point using a wireless signal having a frequency band such as the 2.4 GHz industrial scientific and medical (ISM) band. The wireless LAN device 123 includes a transmitter unit and a receiver unit. The EC/KBC 122 is a power control unit which supplies an operating power to the receiver unit when the computer 10 is in the power-off state.

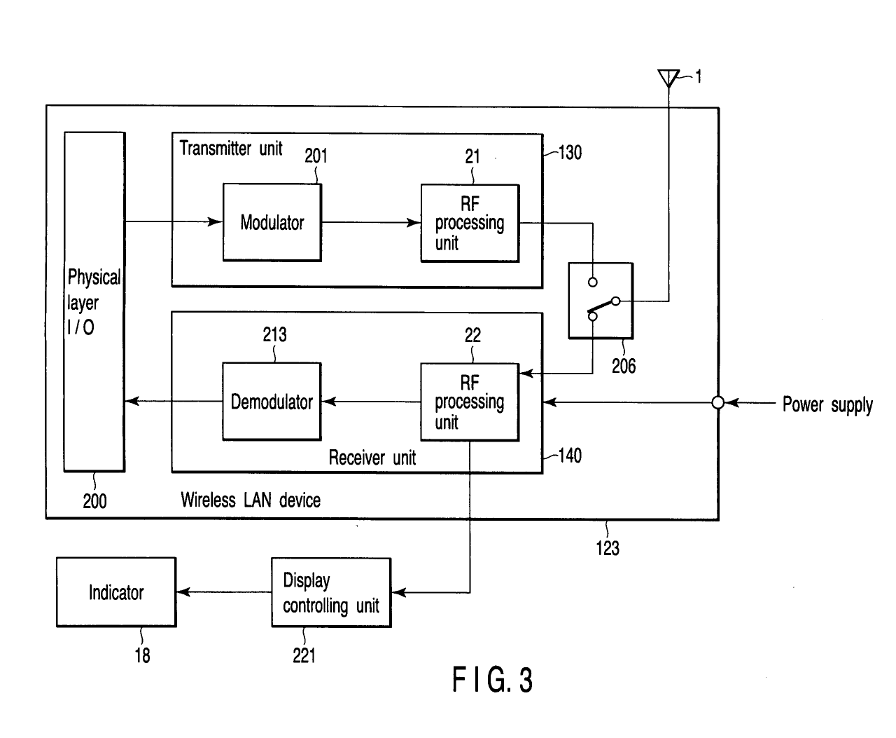

The configuration of the wireless LAN device 123 will be described below with reference to FIG. 3.

The wireless LAN device 123 includes a physical layer input/output (I/O) device 200, a transmitter unit 130, a receiver unit 140 and switch 206. The physical layer I/O device 200 is an interface for connecting the wireless LAN device 123 to a PCI connector.

The transmitter unit 130 includes a modulator 201 and a RF processor 21. The modulator 201 modulates a signal input via the physical layer I/O device 200. The RF processor 21 converts the signal modulated by the modulator 201 into a radio frequency (RF) signal, and thereafter, transmits it externally from an antenna 1 via the switch 206.

The receiver unit 140 includes a RF processing unit 22 and a demodulator 213. The RF processing unit 22 is a wireless signal processing unit which receives a wireless signal from a wireless LAN access point via the foregoing antenna 1 and switch 206. The RF processing unit 22 has a function of detecting strength (electric field strength) of the wireless signal received via the antenna 1. The strength level of the wireless signal received by the RF processing unit 22 is indicated on the indicator 18 via an display controlling unit 221.

The demodulator 213 demodulates the wireless signal received by the RF processing unit 22. The signal obtained by the demodulator 213 is sent to the CPU 111 via the physical layer I/O device 200.

The display controlling unit 221 has a status indication (display) function of indicating status information corresponding to the strength (electric field strength) of the wireless signal received by the RF processing unit 22. The display controlling unit 221 executes analog-to-digital conversion, that is, converts the strength of the wireless signal received by the RF processing unit 22 into a digital signal to evaluate a signal level of the converted digital signal. If the digital signal is more than a predetermined threshold, the display controlling unit 221 lights the indicator 18. Conversely, if the digital signal is less than a predetermined threshold, the display controlling unit 221 flashes the indicator 18. In addition, the display controlling unit 221 is capable of changing a light-emitting color of the indicator 18 in accordance with the detected signal level.

The status indication function is available in a state (including suspend state) that the computer 10 is in a powered off. Usually, when carrying the notebook personal computer, user determines whether or not the current position of the computer exists in the public wireless LAN service area and wireless communication with there is possible. In this case, user must operate the display unit 12 from the closed position to the opening position, and thereafter, operate to make the computer 10 a power-on state.

In the computer 10, power is supplied to the receiver unit 140 of the wireless LAN device 123 under control of the EC/KBC 122 even if the computer 10 is in the power-off state. Therefore, user can confirm wireless communication environment corresponding to the current position of the computer 10 without executing the computer 10 the power-on state.

When power is supplied to the receiver unit 140, power is supplied to both RF processing unit 22 and demodulator 213. In this case, the RF processing unit 22 and the demodulator 213 to which power is supplied, only the processing unit 22 has a relation with the status display function. Therefore, according to the embodiment, the power supply circuit 124 supplies operating power to only the processing unit 22 under control of the EC/KBC 122. That is, the power supply circuit 124 supplies the operating power to the receiver unit 140 under the control of the EC/KBC 122.

By doing so, power consumed for the status display function is reduced.

Usually, the display unit is in a closed position state while user is carrying the notebook personal computer 10. The indicator 18 is arranged on an externally exposed position even if the display unit state is in the closed position. Thus, user can confirm the status information via the indicator 18 without opening the display unit 12 of the computer 10.

As described above, in the computer 10, an operating power is supplied to the RF processing unit 22 in the power-off state of the computer 10. Therefore, it is possible to indicate a signal level of the received wireless signal to user without providing a special detector. Moreover, the transmitter unit 130 and the demodulator 213 of the receiver unit 140 are in the power-off state; therefore, power consumption is reduced to the minimum.

Consequently, user can confirm wireless communication environment corresponding to the current position of the computer 10 in a state of carrying the computer 10 without executing the computer 10 the power-on state and opening the display unit 12. Supply of the operating power to the receiver unit 140 is executed according to an operation of the wireless LAN service area detection button 17 when the computer 10 is in the power-off state. The wireless LAN service area detection button 17 is an operation button which instructs the supply of the operating power to the receiver unit 140 when the computer 10 is in the power-off state or in a suspend state. That is, the EC/KBC 122 has a function of supplying the operating power to the RF processing unit 22 while the wireless LAN service area detection button 17 is pressed by the user in the power-off state of the computer 10. More specifically, the EC/KBC 122 has a function of supplying the operating power to the RF processing unit 22 without supplying the operating power to the transmitter unit 130 and the receiver unit 140 while the wireless LAN service area detection button 17 is pressed by the user in the power-off state of the computer 10. The EC/KBC 122 also has a function of supplying the operating power to the receiver unit 140 for only a time period that the wireless LAN service area detection button 17 is pressed by the user in the power-off state of the computer 10. Moreover, the EC/KBC 122 also has a function of supplying the operating power to the receiver unit 140 for a predetermined time period, when the wireless LAN service area detection button 17 is pressed by the user in the power-off state of the computer 10, and thereafter, stops the supply of the operating power to the receiver unit 140.

Supply of the operating power to the receiver unit 140 of the wireless LAN device 123 may be executed according to an operation of the wireless communication switch 16. That is, the EC/KBC 122 has a function of supplying the operating power to the wireless LAN device 123 when the computer 10 is in the power-on state and the wireless communication switch 16 is set to the on state, and a function of supplying the operating power to the receiver unit 140 in a state that the transmitter unit 130 is in the power-off state when the computer 10 is in the power-off state and the wireless communication switch 16 is set to the on state.

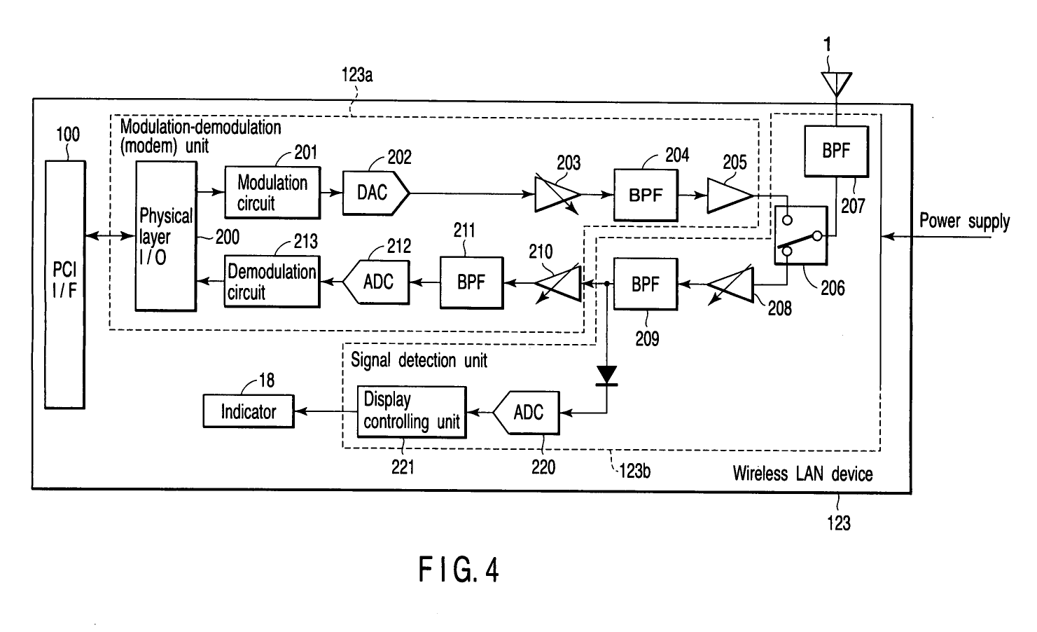

The first system configuration of the wireless LAN device 123 connected to the computer 10 will be explained below with reference to FIG. 4. FIG. 4 shows a detailed system configuration of the wireless LAN device 123 shown in FIG. 3.

As shown in FIG. 4, the wireless LAN device 123 includes a modulator-demodulator (modem) 123a and a signal detection unit 123b.

The modulator-demodulator 123a includes constituted by a modulation circuit 201, a digital-to-analog converter (DAC) 202, a power amplifier 203, a band-pass filters (BPF) 204, 211, a power amplifiers 205, 210, an analog-to-digital converter (ADC) 212 and a demodulation circuit 213.

The signal detection unit 123b includes by a switch 206, a band-pass filters 207, 209, a power amplifier 208, an analog-to-digital converter (ADC) 220 and the display controlling unit 221.

The modulation circuit 201 of the modulator-demodulator 123a corresponds to the function of the modulator 201 shown in FIG. 3. The demodulation circuit 213 of the modulator-demodulator 123a corresponds to the function of the demodulator 213 shown in FIG. 3. The digital-to-analog converter (DAC), the power amplifier 202, 205 and the band-pass filters (BPF) 204 correspond to the function of the RF processor 21 shown in FIG. 3. Part of the signal detection unit 123b is provided with the display controlling unit 221 and the switch 206 shown in FIG. 3. In FIG. 4, the same reference numerals are used to designate components identical to FIG. 3, and the explanation is omitted.

A power amplifier 208, 210, a band-pass filter 209, 211 and an analog-to-digital converter 212 correspond to the function of the RF processing unit 22.

Data to be transmit is input to the modulator circuit 201 via a PCI interface 100 and the physical layer I/O device 200, and then, modulated therein. A signal obtained from the modulator circuit 201 is input to the digital-to-analog converter (DAC) 202, and then, converted into an analog signal. The signal obtained by the DAC 202 is input to the power amplifier 203 so that signal gain is controlled. The signal obtained by the power amplifier 203 is input to the band-pass filter (BPF) 204 so that a 2.4 GHz frequency band signal is extracted. The signal obtained by the band-pass filter 204 is input to the power amplifier 205 so that signal gain is controlled. The signal obtained by the power amplifier 205 is input to the band-pass filter 207 via the switch 206, and thereafter, the 2.4 GHz frequency band signal is extracted. When sending the signal, the switch 206 is changed to connect between the power amplifier 205 and the band-pass filter 207. The signal obtained by the band-pass filter 207 is externally transmitted via the antenna 1.

A wireless signal received via the antenna 1 from a wireless LAN access point is input to the band-pass filter 207, and then, the 2.4 GHz frequency band wireless signal is extracted. The wireless signal obtained by the band-pass filter 207 is input to the power amplifier 208 via the switch 206. When receiving a wireless signal, the switch 206 is changed to make a connection between the band-pass filter 207 and the power amplifier 208. The wireless signal obtained by the power amplifier 208 is input to the band-pass filter 209, and thereafter, the 2.4 GHz frequency band wireless signal is extracted. The wireless signal obtained by the band-pass filter 209 is input to the power amplifier 210. In addition, the wireless signal obtained by the band-pass filter 209 is rectified via a diode, and thereafter, input to the analog-to-digital converter 220. The wireless signal obtained by the power amplifier 210 is input to the analog-to-digital converter (ADC) 212 via the band-pass filter 211, and then, converted into a digital signal. The digital signal obtained by the ADC 212 is input to the demodulation circuit 213, and thereafter, demodulated therein. The signal obtained by the demodulation circuit 213 is sent to the CPU 111 via the physical layer I/O device 200 and the PCI interface 100.

Conversely, the signal input to the analog-to-digital converter 220 is converted into a digital signal. The digital signal obtained by the ADC 220 is input to the display controlling unit 221, and then, the indicator 18 indicates a signal level of the received wireless signal.

A first status display function of the embodiment will be described below. The status display function is performed when the computer 10 is in the power-off state (including suspend state).

When the computer 10 is in the power-off state, the power supply circuit 124 supplies power to only signal detection unit 123b under control of the EC/KBC IC 122. The signal detection unit 123b supplied with power receives a wireless signal via the antenna 1. The received wireless signal is input to the display controlling unit 221 via the analog-to-digital converter 220. The display controlling unit 221 indicates a signal level showing wireless communication environment corresponding to the current position of the computer 10 via the indicator 18 in accordance with radio strength of the input wireless signal.

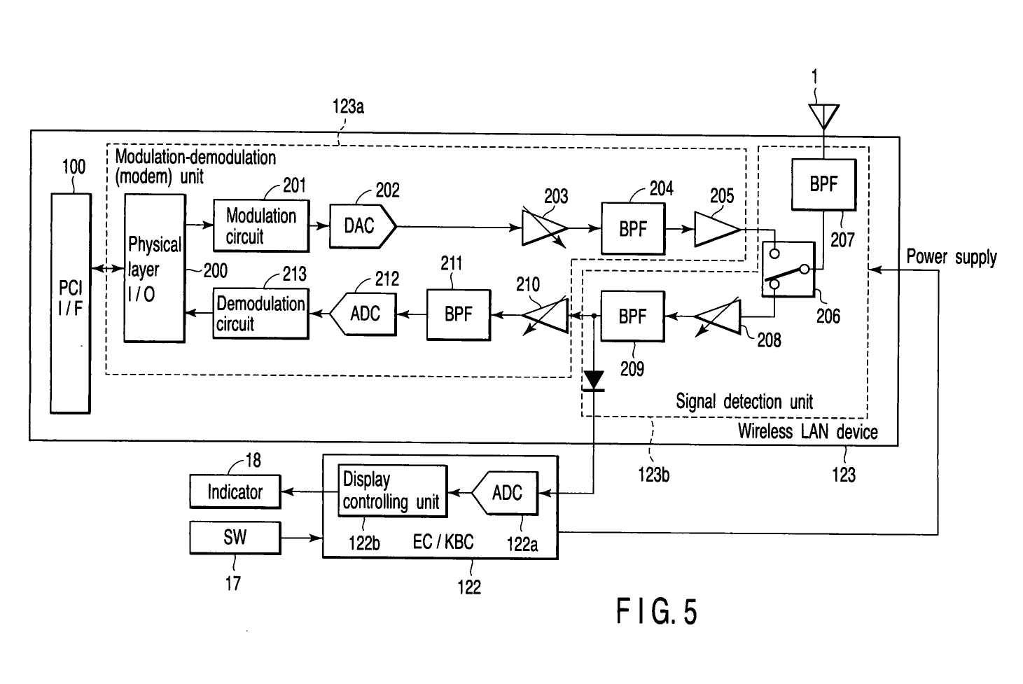

FIG. 5 shows a second system configuration of the wireless LAN device 123 and the EC/KBC 122. FIG. 5 shows a detailed system configuration of the wireless LAN device 123 shown in FIG. 3.

The EC/KBC IC 122 includes analog-to-digital converter (ADC) 122a and indication controller 122b. These analog-to-digital converter (ADC) 122a and indication controller 122b have the foregoing status display function. Specifically, part of the EC/KBC IC 122 shown in FIG. 5 is provided with the indication controller 122 shown in FIG. 3. In FIG. 5, the same reference numerals are used to designate components identical to the wireless LAN device 123 shown in FIG. 4.

A second status display function of the embodiment will be explained below. The status display function is performed when the computer 10 is in the power-off state (including suspend state).

When the computer 10 is in the power-off state, the power supply circuit 124 supplies power to the signal detection unit 123b by time when user presses the wireless LAN service area detection button 17, under control of the EC/KBC 122. The signal detection unit 123b supplied with power receives a wireless signal via the antenna 1. The received wireless signal is input to the display controlling unit 221 via the analog-to-digital converter 122a. The display controlling unit 221 indicates a signal level showing wireless communication environment corresponding to the current position of the computer 10 via the indicator 18 in accordance with radio strength of the input wireless signal. Consequently, the computer 10 indicates signal level showing wireless communication environment corresponding to the current position of the computer 10 for only a time period that user presses the wireless LAN service area detection button 17. When user releases the wireless LAN service area detection button 17, the status display function is stopped. In other words, the power supply to the signal detection unit 123b is stopped.

Moreover, the status display function may be set to perform for a predetermined time when user presses the wireless LAN service area detection button 17.

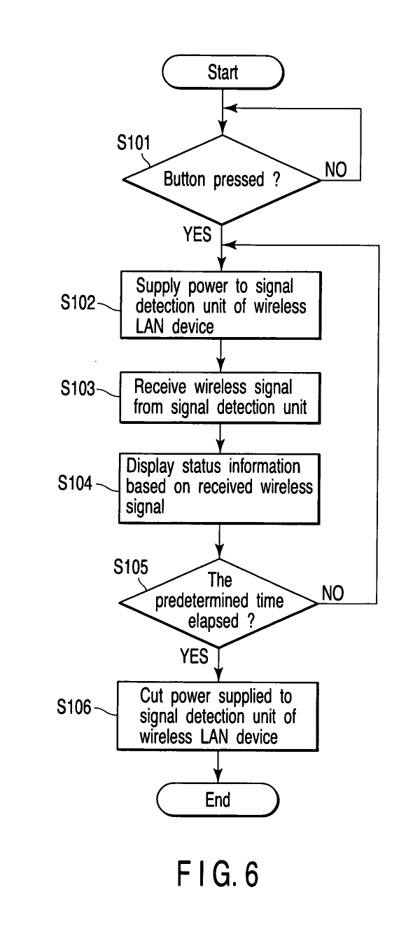

The procedure of the status display function performed when user operates the wireless LAN service area detection button 17 will be explained below with reference to a flowchart of FIG. 6. The wireless LAN service area detection button 17 is an operation switch which instructing power-on of the receiver unit 140. The EC/KBC 122 executes the status display function when the computer 10 is in the power-off state or in the suspend state.

The EC/KBC 122 determines whether or not user operates the wireless LAN service area detection button 17 (block S101). If the wireless LAN service area detection button 17 is operated (YES in block S101), the EC/KBC 122 controls the power supply circuit 124 to supply power to the signal detection unit 123b of the wireless LAN device 123 (block S102). In block S102, only signal detection unit 123b of the wireless LAN device 123 is activated. The signal detection unit 123b supplied with power receives a wireless signal (block S103). In block S103, signal detection unit 123b supplied with power receives the wireless signal via the antenna 1 from a wireless LAN access point.

The EC/KBC 122 displays status information based on the received wireless signal (block S104). In block S104, the display controlling unit 221 or 122b displays a signal level corresponding to the current position of the computer 10 via the indicator in accordance with the radio strength of the received wireless signal.

The EC/KBC 122 determines whether or not a predetermined time elapses after the wireless LAN service area detection button 17 is operated (block S105). If the predetermined time elapses (YES in block S105), the EC/KBC 122 cut off power supplied to the signal detection unit 123b of the wireless LAN device 123 (block S106).

Conversely, if the predetermined time does not elapse (NO in block S105), the EC/KBC 122 supplies power to the signal detection unit 123b of the wireless LAN device 123 (block S102). Then, the EC/KBC 122 continues to supplies power to the signal detection unit 123b until the predetermined time elapses (from block S102 to block S104).

Moreover, the block S101 may be skipped. In this case, trigger of the wireless LAN service area detection button 17 for starting the status display function is deleted. By doing so, the status display function is started from block S102.

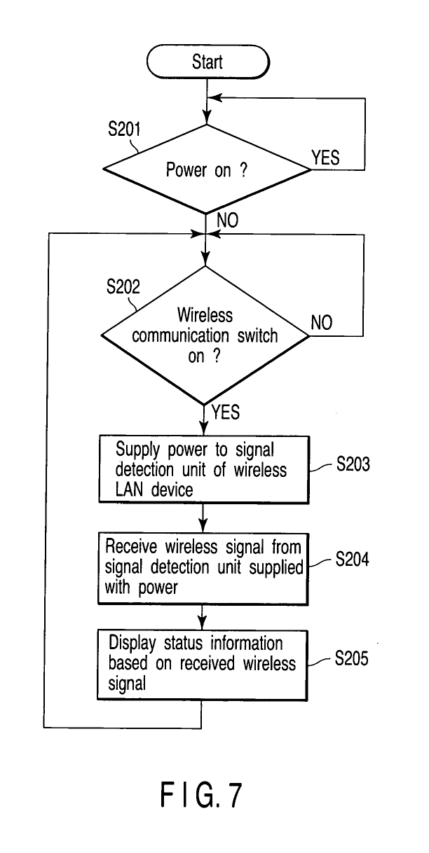

A status display function performed when user sets the wireless communication switch 16 to an on state will be explained below with reference to a flowchart of FIG. 7. The status display function is performed only when the computer 10 is in a power-off or the suspend state and when the wireless communication switch 16 is set to an on state. In this case, the power supply circuit 124 supplies power to the signal detection unit 123b in a state that the modulation-demodulation unit 123a is made the power-off state, under control of the EC/KBC 122.

The EC/KBC 122 determines whether or not the computer 10 is in the power-off state or the suspend state (block S201). If the computer 10 is in the power-off state or the suspend state (YES in block S201), the EC/KBC 122 determines whether or not user operates the wireless communication switch 16, that is, the wireless communication switch 16 is set to an on state (block S202). If user sets the wireless communication switch 16 to an on state (YES in block S202), the EC/KBC 122 supplies power to the signal detection unit 123b of the wireless LAN device 123 (block S203). In block S203, only signal detection unit 123b of the wireless LAN device 123 is activated. The EC/KBC 122 receives a wireless signal from the signal detection unit 123b supplied with power (block S204). In block S204, the signal detection unit 123b receives the wireless signal via the antenna 1 from a wireless LAN access point.

The EC/KBC 122 displays status information based on signal strength of the received wireless signal (block S205). In block S205, the display controlling unit 221 or 122b displays a signal level corresponding to the signal strength of the received wireless signal via the indicator 18.

The EC/KBC 122 displays the signal level via the indicator 18, and thereafter, again determines whether or not the wireless communication switch 16 is set to an on state (block S202). The EC/KBC 122 continues to supply power to the signal detection unit 123b while the wireless communication switch 16 is set to an on state, and to receive a wireless signal provided from the wireless LAN access point (from block S202 to block S205).

According to the embodiment, it is possible to provide a signal level showing radio strength from a wireless LAN access point to user without using a special detector which detect the wireless LAN service are and without activating the computer 10. Therefore, user can readily confirm whether or not the computer 10 exists in the wireless LAN service area based on the signal level indicated via the indicator 18.

In the embodiment, the signal level corresponding to the wireless signal received by the receiver unit 140 may be displayed via the indicator 18.

The status display function is performed when the wireless LAN service area detection button 17 is operated even if the wireless communication switch 16 is in an off state.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus capable of executing wireless communication, comprising:
a wireless communication unit which includes a transmitter and a receiver, and which executes the wireless communication using a predetermined frequency band wireless signal;
a power control unit which supplies an operating power to the receiver when the information processing apparatus is in a power-off state; and
an indication unit which indicates status information showing wireless communication environment corresponding to a current position of the information processing apparatus in accordance with a strength of the wireless signal received by the receiver.

2. The information processing apparatus according to claim 1, wherein the receiver includes a wireless signal processing unit which receives the wireless signal via an antenna, and a demodulator which demodulates the received wireless signal, and
the power control unit supplies the operating power to the wireless signal processing unit of the receiver when the transmitter and the demodulator of the receiver are in a power-off state.

3. The information processing apparatus according to claim 1, further comprising an operation switch instructing power-on of the receiver,
wherein the power control unit supplies the operating power the receiver when the operation switch is operated in a power-off state of the information processing apparatus.

4. The information processing apparatus according to claim 3, wherein the receiver includes a wireless signal processing unit which receives the wireless signal via an antenna, and a demodulator which demodulates the received wireless signal, and
the power control unit supplies the operating power to the wireless signal processing unit of the receiver in a state that the transmitter and the demodulator of the receiver are in a power-off state when the operation switch is operated in a power-off state of the information processing apparatus.

5. The information processing apparatus according to claim 1, further comprising an operation switch which instructs power-on of the receiver,
wherein the power control unit supplies the operating power to the receiver for only a time period that the operation switch is pressed in a power-off state of the information processing apparatus.

6. The information processing apparatus according to claim 1, further comprising an operation switch which instructs power-on of the receiver,
wherein the power control unit supplies the operating power to the receiver for a predetermined time period, when the operation switch is pressed in a power-off state of the information processing apparatus, and thereafter, stops the supply of the operating power to the receiver.

7. The information processing apparatus according to claim 1, further comprising an operation switch which sets one of an on state of instructing power-on of the wireless communication unit and an off state of instructing power-off of the wireless communication unit; and
wherein the power control unit supplies the operating power to the wireless communication unit when the information processing apparatus is in a power-on state and the operation switch is set to the on state, and supplies the operating power to the receiver in a state that the transmitter is in a power-off state when the information processing apparatus is in a power-off state and the operation switch is set to the on state.

8. The information processing apparatus according to claim 7, wherein the receiver includes a wireless signal processing unit which receives the wireless signal via an antenna, and a which demodulates the received wireless signal, and
the power control unit supplies an operating power to the wireless signal processing unit of the receiver in a state that the transmitter and the demodulator of the receiver are in a power-off state when the information processing apparatus is in a power-off state and the operation switch is set to an on state.

9. The information processing apparatus according to claim 1, further comprising:
a housing; and
a display unit supported to the housing, and rotatable between a closed position covering an upper surface of the housing and an opening position in which the upper surface of the housing is exposed,
the indication unit arranged on an externally exposed position on the housing in a state that the display unit is situated on the closed position.

10. The information processing apparatus according to claim 9, further comprising an operation switch which is arranged on an externally exposed position on the housing in a state that the display unit is situated on the closed position, and instructs to supply an operating power to the receiver,
wherein the power control unit which supplies the operating power to the receiver when the operation switch is operated in a power-off state of the information processing apparatus.
